(19) United States
(12) Patent Application Publication
(10) Pub. No.: US 2011/0277922 A1
(43) Pub. Date: Nov. 17, 2011

(54) BASE MATERIAL MANUFACTURING METHOD, NANOIMPRINT LITHOGRAPHY METHOD AND MOLD DUPLICATING METHOD

(75) Inventors: Osamu Masuda, Tokyo (JP); Motohiro Yamada, Kyoto (JP)

(73) Assignee: KONICA MINOLTA HOLDINGS, INC., Tokyo (JP)

(21) Appl. No.: 13/146,536

(22) PCT Filed: Jan. 25, 2010
(86) PCT No.: PCT/JP2010/050887

§ 371 Date: Jul. 27, 2011

(30) Foreign Application Priority Data
Feb. 3, 2009 (JP) 2009-022387

(51) Int. Cl. B29C 37/00; B05D 1/32

(52) U.S. Cl. 156/232; 427/282

(57) ABSTRACT

Disclosed are a base material manufacturing method, in which transfer of the structure of a mold to the entire surface of a base material is possible, irrespective of planarity of the mold or the base material, and in-plane uniformity of the transfer and uniformity of in-plane distribution of a remaining layer thickness can be achieved, and a nanoimprint lithography method and a mold duplicating method employing the base material manufacturing method. The method comprises forming on a transfer mold a cured layer composed of a transfer material, superposing on the surface of the cured transfer material layer a base material having a surface capable of adhering to the cured transfer material layer by physical interaction so that the cured material layer and the base material are adhered to each other to form an integrated material, and then separating the integrated material from the transfer mold to obtain a base material with the transfer material layer transferred thereon.

### TECHNICAL FIELD

This invention relates to a base material manufacturing method comprising transferring a pattern structure of a mold to a base material, and a nanoimprint lithography method and a mold duplicating method each employing the base material manufacturing method.

### TECHNICAL BACKGROUND

The nanoimprint lithography method is a lithography in which transfer of a fine structure of a mold is carried out by pattern pressing, and is said to provide a degree of resolution of around 10 nm, although. it is a simple and inexpensive method (refer to Non-patent document 1). The process of a conventional nanoimprint lithography method is shown in FIG. 15.

As is shown in FIG. 15, an ultraviolet ray curable resin 103 is coated on a base material 102 by a spin coating method or the like (a). Subsequently, while the resin layer 103 is pressed by a mold 101 having a fine structure 101a composed of a fine concave and convex structure, the resin layer 103 is subjected to ultraviolet ray irradiation to form a cured resin layer 103 (b), followed by separation to separate the cured resin layer 103 from the mold 101 (c). Subsequently, a remaining layer 104 of the resin layer 103 on the base material 102 was removed by ashing treatment (d), and then the base material 102 was subjected to etching treatment to process the base material 102 (e). Finally, the resin layer 103 was completely removed, whereby a base material 102 having a fine structure 105 corresponding to the fine concave and convex structure 101a of the mold 101 is manufactured (f).

A nanoimprint method employing an ultraviolet ray curable resin, as described above, is generally called a photo nanoimprint method or a UV (ultraviolet ray) nanoimprint method. In FIG. 15, a nanoimprint method may be a method in which employing a thermoplastic resin as a resin, transfer of the fine structure 101a of the mold 101 is carried out by heat and pressure application. This method is called a heat nanoimprint method.

Patent document 1 discloses an imprint apparatus, an imprint method and a method of manufacturing a chip, which comprise pressing a mold to a processing material while partially supporting the processing material at a support portion, in order to reduce an influence due to bending of a processing material during imprinting.

Patent document 2 discloses a method comprising the steps of providing a sealing gasket between a mold and a support member so that a pressure cavity is formed thereby, and applying a static gas pressure to the pressure cavity to apply a pressure between the mold and the support member, whereby a uniform pressure is applied.

Patent document 3 discloses a method comprising the steps of coating a polymer on a mold to form a polymer coat, and transferring the polymer coat from the mold to a base material at appropriate temperature and pressure to obtain an imprint base material having an intended micro/nano structure thereon. For example, transfer of the polymer coat to the base material is carried out in a heated hydraulic press at intended temperature and pressure (claim 16), for example, at a temperature of approximately 90° C. and at a pressure of approximately 5 MPa (claim 30).

### PRIOR ART LITERATURES

### Patent Documents

Patent Document 1: Japanese Patent O.P.I. Publication No. 2007-19479
Patent Document 2: U.S. Pat. No. 7,144,539
Patent Document 3: Japanese Unexamined Patent Application Publication (Translation of PCT Application) No. 2005-524984
Patent Document 4: Japanese Patent O.P.I. Publication No. 2004-103817

### Non-Patent Documents

Non-Patent Document 1: S. Y. Chou, P. R. Kraussand, P. J. Renstrom, Science 85, 272 (1996)

### DISCLOSURE OF THE INVENTION

### Problems to be Solved by the Invention

In any of the method as shown in FIG. 15 and methods disclosed in Patent documents 1 and 2, when a fine structure is transferred in a relatively large area, there occurs problem as shown in FIG. 16. That is, a flatness (μm order) of a mold 101 or a base material 102, bending (μm order) of a mold 101 or a base material 102 each supported and a relative position relationship (tilt) between the mold 101 or the base material 102 are larger than a fine structure (nm order), respectively. Therefore, as is shown in FIG. 16, a region A where the fine structure is transferred and a region B where the fine structure is not transferred occur in the resin layer 103, resulting in in-plane non-uniformity of transfer. Further, even if the whole of the fine structure is transferred, in-plane variation of a remaining layer 104 occurs, and therefore, when the steps (d), (e) and (f) of FIG. 15 are carried out, there occurs a fault such as variation in the depth of the concave and convex structure of the fine structure 105 formed on the base material 102.

For example, the flatness (PV) of a silicon wafer generally used as a base material is around 5 μm (measurement area diameter 50 mm), and the flatness (PV) of a quartz wafer generally used as a mold is approximately the same as above. Accordingly, when a general base material and a general mold are employed and the fine structure in nm order is transferred, a problem such as in-plane non-uniformity of transfer or in-plane variation of a remaining layer may occur as is shown in FIG. 15 described above.

The method disclosed in Patent document 1, which comprises pressing while partially supporting a processing material to reduce an influence due to bending of the processing material during supporting, is basically a manufacturing method of a semiconductor chip, where the size of the chip is around 20 mm square. This method is not one reducing an influence due to flatness of a mold or a base material.

The method disclosed in Patent document 2, in which pressing is carried out by applying a gas pressure, improves uniformity of the pressing pressure, whereby an influence due to bending during supporting is reduced and a relative position relationship between the mold and the base material is improved. However, this method does not produce a pressure sufficient to correct a flatness of a base material and a mold.

The method disclosed in Patent document 3 is one which comprises coating a polymer coat on a mold and transferring the polymer coat from the mold to a base material at an appropriate temperature and pressure, and therefore, it is difficult that good adhesion is reproduced due to the individual difference in planarity of a mold or a base material. In order to transfer the polymer coat to the base material at an appropriate temperature and pressure, the temperature, the pressure and the supporting time need to be controlled simultaneously and the processing steps cannot be divided. Therefore, the throughput is difficult to increase, and productivity is difficult to improve. Further, a heated hydraulic press is necessary during transfer, and therefore when transfer is carried out at a large area, a pressure apparatus of large size is necessary.

In order to solve the problems as described above, the present invention has been made. An object of the invention is to provide a base material manufacturing method, in which transfer of the structure of a mold to the entire surface of a base material is possible, irrespective of planarity of the mold or the base material, and in-plane uniformity of the transfer and uniformity of in-plane distribution of the remaining layer thickness can be achieved, and a nanoimprint lithography method and a mold duplicating method employing the base material manufacturing method.

### Means for Solving the Above Problems

The above object has been attained by the following method. The base material manufacturing method of the invention is featured in that it comprises the steps of forming a cured layer composed of a transfer material on a transfer mold, superposing, on the surface of the resulting cured transfer material layer, a base material having a surface capable of adhering to the cured transfer material layer by physical interaction, whereby the cured material layer and the base material are adhered to each other together to form an integrated material, and then separating the resulting integrated material from the transfer mold to obtain a base material with the transfer material layer transferred thereon.

According to this base material manufacturing method, when a base material is superposed on a cured transfer material layer on a transfer mold, the surfaces of the transfer material layer and the base material adsorb each other by physical interaction, so that the transfer material layer and the base material can be adhered to each other without employing any adhesive therebetween. Thus, the transfer material layer and the base material adhered to each other form an integrated material, and the integrated material can be separated from the transfer mold. Thus, a base material with the transfer material layer transferred thereon can be obtained. Herein, the cured transfer material layer is formed on the transfer mold, and an integrated material, in which the transfer material layer and the base material are integrally formed, is separated from the transfer mold, which makes it possible to transfer a mold structure on the entire surface of the base material irrespective of the planarity of the transfer mold or the base material. Since pressure load is not applied to a transfer mold and a base material in the supported state, the base material manufacturing method can obviate in-plane non-uniformity of transfer or in-plane variation of a remaining layer thickness of a transfer material layer, which results from bending occurring when the transfer mold or the base material is supported or a position relationship (tilt or the like) between the transfer mold and the base material. According to the base material manufacturing method, a base material with a mold structure precisely transferred thereon can be manufactured at low cost.

In the base material manufacturing method above, the base material and the transfer material layer adsorb each other together according to the surface planarity at an ordinary temperature and at an ordinary pressure or at an ordinary temperature and at a reduced pressure, irrespective of the planarity of the surfaces of the base material and the transfer material layer.

The transfer mold has a fine structure, and the fine structure is transferred onto a surface of the transfer material layer opposite the surface facing the base material. As the fine structure, there is, for example, a periodic concave and convex structure.

It is preferred that the transfer material comprises at least one selected from an ultraviolet ray curable resin, a heat curable resin, a thermoplastic resin, a photoresist, an electron beam resist and a spin on glass (SOG).

The transfer material layer can be formed by coating the transfer material onto the transfer mold and then curing it. It is preferred that the coating of the transfer material layer is carried out employing at least one selected from a spin coating method, a spray coating method, a dip coating method and a bar coating method. Herein, when the transfer material layer is coated onto the transfer mold, the coating method is selected according to the thickness of a layer coated. When the coating thickness is of nm to μm order, a spin coating method or a spray coating method is suitable and when the coating thickness is over nm to μm order, a bar coating method or a spray coating method is suitable. When the coating thickness is extremely low as that of a monomolecular film composed of a monomer or an oligomer, a dip coating method is suitable.

It is preferred that the coated transfer material layer is cured employing at least one curing treatment selected from ultraviolet ray curing treatment, heat curing treatment and solvent volatilization treatment. A plurality of curing methods may be used in combination. For example, when a ultraviolet ray curable resin or a heat curable resin diluted with a solvent is employed, the solvent is volatilized by heat application, followed by ultraviolet ray curing treatment or heat curing treatment.

It is preferred that the transfer material layer is formed on the transfer mold, employing at least one selected from vapor deposition, vapor deposition polymerization, CVD and spattering.

The transfer mold is preferably composed of at least one selected from silicon, quartz, SOG, a resin and a metal, and may be a composite thereof.

The base material is preferably composed of at least one selected from quartz, glass, silicon, a resin and a metal, and may be a composite thereof.

Materials for the base material, the transfer material layer and the transfer mold are combined so that the adhesion force between the base material and the transfer material layer is greater than that between the transfer material layer and the transfer mold, whereby the base material with the transfer material layer can be stably separated from the transfer mold.

Prior to the superposing as described above, at least one of the surfaces of the base material and the transfer material layer to adhere to each other is subjected to pre-treatment so that the adhesion force between the base material and the transfer material layer is greater than that between the transfer material layer and the transfer mold, whereby the base material with the transfer material layer can be stably separated from the transfer mold. Herein, it is preferred that the pre-treatment is carried out employing one selected from UV ozone treatment, primer treatment, oxygen ashing treatment, charging treatment, nitrogen plasma treatment and washing treatment.

The base material and the transfer material layer adhered to each other are allowed to stand for a certain period of time or subjected to heat treatment, electrostatic adsorption treatment or pressure application treatment, followed by the separation, whereby the adhesion between the base material and the transfer material layer is increased.

The nanoimprint lithography method of the invention is featured in that it comprises the step of subjecting the base material manufactured according to the base material manufacturing method as described above to lithography processing, employing the transfer material layer as a mask.

According to the nanoimprint lithography method, the structure of a mold can be transferred to the entire surface of the base material, independently of the planarity of the transfer mold or the base material, wherein in-plane uniformity of the transfer and uniformity of in-plane distribution of the thickness of the remaining film can be achieved, so that accuracy of the transfer material layer is improved, and therefore, lithography processing with high precision can be carried out. Herein, it is preferred that the transfer material layer, after removal of the remaining film, is subjected to the lithography processing as above.

Another nanoimprint lithography method of the invention is featured in that it comprises the steps of transferring another transfer material layer onto another base material, employing the transfer material layer of the base material manufactured according to the base material manufacturing method as described above, and subjecting the another base material with another transfer material layer transferred to lithography processing employing the another transfer material layer as a mask.

According to the nanoimprint lithography method, the structure of a mold can be transferred to the entire surface of the base material, independently of the planarity of the transfer mold or the base material, wherein in-plane uniformity of the transfer and uniformity of in-plane distribution of the thickness of the remaining film can be achieved, so that accuracy of the transfer material layer is improved, and therefore, lithography processing with high precision can be carried out. Herein, the another transfer material can be changed to material suitable for lithography processing, in which lithography processing can be conducted with further stability.

The mold duplicating method of the invention is featured in that it comprises the step of duplicating a transfer mold, employing the base material with the transfer material layer transferred thereon, manufactured according to the base material manufacturing method as described above.

According to the mold duplicating method, the structure of a mold can be transferred to the entire surface of the base material, independently of the planarity of the transfer mold or the base material, wherein in-plane uniformity of the transfer and uniformity of in-plane distribution of the thickness of the remaining layer can be achieved, so that accuracy of the transfer material layer is improved, and therefore, a transfer mold can be duplicated with high precision. The transfer mold is expensive to manufacture, and of high price, but according to this method, a duplicate mold with high precision can be manufactured at low cost.

In the mold duplicating method as described above, the base material with the transfer material layer transferred can be regarded as a second generation transfer mold.

Employing the base material with the transfer material layer transferred as a second generation transfer mold, a second transfer material layer is transferred onto a second base material, and employing the second base material with the second transfer material layer transferred, a third generation transfer mold can be manufactured.

In this document, the term “transfer” implies that the transfer material layer is transferred onto the base material to form an integrated material or that the mold structure (fine structure) is formed on the surface of the transfer material layer.

The term, “planarity” is a deviation from the geometrical plane, and implies a degree of planarity (flatness: difference between the maximum (peak) and the minimum (valley) in a plane) and a structure of a plane (camber, waviness).

### Effects of the Invention

According to the base material manufacturing method of the invention, transfer of the structure of a mold to the entire surface of a base material is possible, irrespective of planarity of the transfer mold or the base material, and in-plane uniformity of the transfer and uniformity of in-plane distribution of the remaining layer thickness of the transfer material layer can be achieved.

### BRIEF EXPLANATION OF THE DRAWINGS

FIG. 1 is a drawing for explaining the steps (a) to (f) in the base material manufacturing method of a first embodiment.

FIG. 2 shows the side views (a) to (c) of the base material, and is a drawing for explaining in detail the steps (c), (d) and (f) in the base material manufacturing method of FIG. 1.

FIG. 3 is a side view, which schematically shows the manner that the resin layer 12 and the base material 13 in FIGS. 1 and 2 are adsorbed with each other, in order to explain self adsorption of the two.

FIG. 4 is a drawing for explaining a principle in which a resin layer is transferred onto a base material in the base material manufacturing method of FIG. 1 or 2.

FIG. 5 is a drawing for explaining adhesion force Fa between the resin and the base material and adhesion force Fb between the resin and the silicon (mold) prior to pre-treatment before the self adsorption.

FIG. 6 is a drawing for explaining pre-treatment (a first example) before the self adsorption in a second embodiment.

FIG. 7 is a drawing for explaining pre-treatment (a second example) before the self adsorption, as in FIG. 6.

FIG. 8 is a drawing for explaining a combination (a third example) of each material in a second embodiment.

FIG. 9 is a drawing for explaining the steps (a) to (i) of a nanoimprint lithography method in a third embodiment.

FIG. 10 is a drawing for explaining the steps (a) to (f) of a manufacturing method (a third example) of the third generation transfer mold composed of SOG in a fourth embodiment.

FIG. 11 is a drawing for explaining the steps (a) to (f) of a manufacturing method (a fourth example) of the third generation transfer mold composed of SOG in a fourth embodiment.

FIG. 12 is a drawing for explaining the steps (a) to (h) of a manufacturing method (a fifth example) of the third generation transfer mold composed of quartz in a fourth embodiment.

FIG. 13 is a scanning electron micrograph of the fine structure of the surface of the base material onto which the transfer material was transferred in Example 1.

FIG. 14 shows a scanning electron micrograph of the fine structure of the surface of the transfer mold duplicated from a transfer mold in Example 2.

FIG. 15 is a drawing showing the steps (a) to (i) of a conventional nanoimprint lithography method.

FIG. 16 is a drawing showing problems occurring in a conventional method as is shown in FIG. 15 or disclosed in patent documents 1 and 2.

### PREFERRED EMBODIMENT OF THE INVENTION

Next, embodiments of the invention will be explained employing the figures.

### First Embodiment

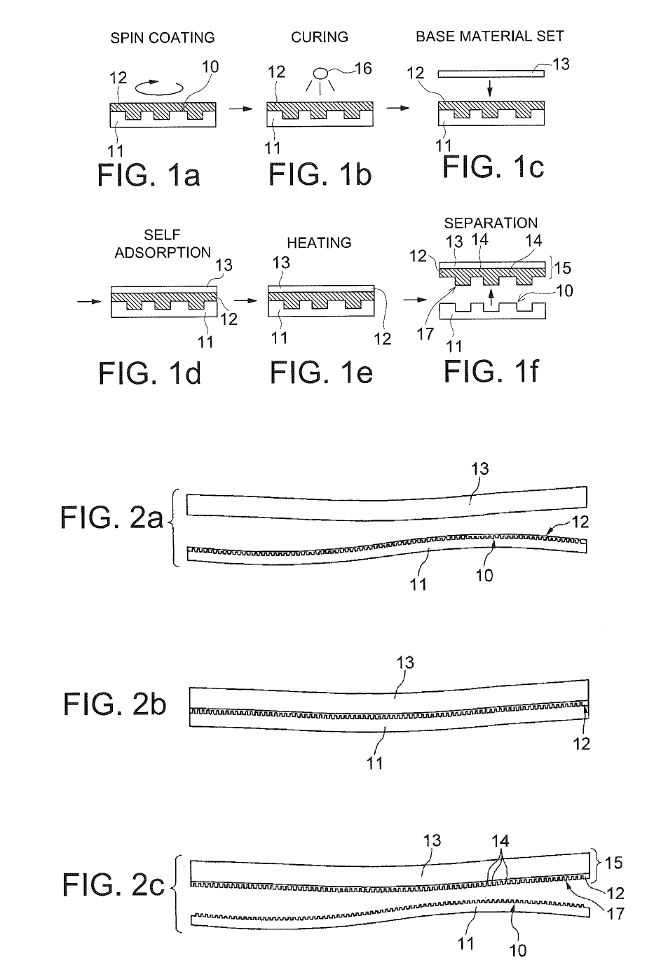

FIG. 1 is a drawing for explaining the steps (a) to (f) in the base material manufacturing method of a first embodiment. FIG. 2 shows the side views (a) to (c) of the base material, and is a drawing for explaining in detail the steps (c), (d) and (f) in the base material manufacturing method of FIG. 1. Referring to FIGS. 1 and 2, the base material manufacturing method in this embodiment will be explained. In FIGS. 1 and 2 and Figures described later, the fine structure of a mold and thickness or planarity of the mold or a base material will be exaggeratedly illustrated.

As is shown in FIG. 1(a), a transfer mold 11 is provided which is composed of a silicon wafer and has a fine concave and convex structure 10. An ultraviolet ray curable resin as a transfer material is coated on the surface of the transfer mold 11 via a spin coating method, the surface having a fine concave and convex structure 10, thereby forming a resin layer 12 as the transfer material layer. According to the spin coating method, the resin layer 12 as the transfer material layer is formed with uniform thickness and high precision.

The transfer mold 11 can be prepared, for example, by preparing a resist mask via electron beam writing and forming a fine concave and convex structure on the silicon wafer via etching processing, but the preparation thereof is not limited thereto.

Subsequently, as is shown in FIG. 1(b), the resin layer 12 is subjected to ultraviolet ray irradiation from an ultraviolet lamp 16 to cure the resin layer 12, whereby the cured resin layer 12 is formed on the transfer mold 11 with uniform and precise thickness. When a heat curable resin is used as a transfer material, the resin layer is subjected to heat application treatment instead of ultraviolet ray irradiation to cure the resin layer 12 in the step of FIG. 1(b). When an electron beam resist or a photoresist is used as a transfer material, the resin layer is subjected to baking treatment to volatilize the solvent, thereby curing the resin layer 12 in the step of FIG. 1(b).

As is shown in FIGS. 1(c) and 1(d), a base material 13 composed of quartz in the form of a thin film is put and superposed onto the cured resin layer 12 on the transfer mold 11 to adhere to the cured resin layer. Herein, the resin layer 12 and the base material 12 adsorb (self-adsorb) each other without employing any adhesive therebetween.

Subsequently, the resin layer 12 and the base material 13 are heated in FIG. 1(e), whereby adhesion between the resin layer 12 and the base material 13 is enhanced. It is preferred in this case that the heating temperature is not lower than a glass transition point of the resin employed.

After the resin layer 12 and the base material 13 heated are cooled to room temperature, the resin layer 12 and the base material 13 are separated from the transfer mold 11, as is shown in FIG. 1(e).

According to the steps (a) to (f) above, the resin layer 12 is transferred onto the base material 13, and a base material 15 having a resin layer 12 with a fine concave and convex structure 17 can be manufactured, the fine concave and convex structure 17 being formed by transfer of a fine concave and convex structure 10 of the transfer mold 11 onto a surface of the resin layer 12 opposite the surface facing the base material 13. The fine concave and convex structure 17 of the resin layer 12 has a structure in which the fine concave and convex structure 10 of the transfer mold 10 is inversed.

The base material manufacturing method of the invention has the following advantageous effects.

(1) As is shown in FIG. 2(a), even if the transfer mold 11 and the base material 13 has a planarity of around several micrometer, a resin is coated on the surface having the fine concave and convex structure 10 of the transfer mold 11 and cured to form a resin layer 12. After that, the base material 13 is adhered to the resin layer and the resin layer 12 with the base material 13 is separated from the transfer mold 11, as is shown in FIG. 2(b), and then the fine concave and convex structure 10 of the transfer mold 11 can be transferred onto the entire surface of the resin layer 12, as is shown in FIG. 2(c), whereby the transfer of the fine concave and convex structure 10 is carried out to be uniform in plane. The thickness of the remaining layer 14 at the concave of the fine concave and convex structure 17 transferred and formed onto the resin layer 12 is entirely uniform in plane, as is shown in FIG. 1(f) and FIG. 2(c).

(2) As is shown in FIG. 2(b), on adhesion between the base material 13 and the resin layer 12 formed on the transfer mold 11, the base material 13 and the resin layer 12 adsorb (self-adsorb) each other at an ordinary temperature and at an ordinary pressure according to each plane irrespective of planarity of each surface thereof, whereby the resin layer 12 and the base material 13 are integrated. Therefore, the resin layer 12 and the base material 13 integrated can be separated from the transfer mold 11, whereby the resin layer 12 can be transferred onto the base material 13.

(3) Since pressure load is not applied to the transfer mold 11 and the base material 13 in the supported state, the base material manufacturing method can obviate in-plane non-uniformity of transfer or in-plane variation of the remaining layer thickness, which results from bending occurring when the base material 13 is supported or a position relationship (tilt and the like) between the transfer mold 11 and the base material 13.

(4) Since the resin layer 12 is coated via a spin coating method, which has a uniform thickness with high precision, and cured, the resin layer 12 cured, onto which the fine concave and convex structure 10 of the transfer mold 11 has been transferred, can maintain the uniformity and high precision of the thickness.

(5) Since the resin layer (transfer material layer) 12 and the base material 12 can be adhered to each other via adsorption (self adsorption) corresponding to their surface planarity irrespective of planarity of the surfaces thereof, there is no limitation of the size of the mold or the base material. Further, since no press application is required at the adhering step, a pressure apparatus of large size indispensable for a conventional nanoimprint method is not necessary. Furthermore, the self adsorption speed is high, for example, time during which a 4 inch mold is adhered to a base material is several seconds, and when a through put is considered, the adhering step is not a rate determining step, and has no adverse influence on productivity.

(6) In a process in which a mold with a concave and convex structure is pressed onto a resin to transfer the structure to the resin, as is the case with a prior art, when the resin penetrates into the concave portion of the mold, air is enclosed in the concave portion, whereby a prescribed structure may not be formed. In order to solve this problem, for example, in Patent document 4, occurrence of the deficiencies is prevented by imprinting under atmosphere of air which is liquefied under applied pressure. On the other hand, according to the base material manufacturing method of the invention, the concave is filled with a transfer material via coating but not via applied pressure. Therefore, the method of the invention makes it possible to closely fill the concave portion with the transfer material without employing a step such as one carried out under atmosphere of air as disclosed in Patent document 4, whereby a transfer material layer with a structure which faithfully reproduces the structure of a mold can be manufactured.

(7) As described above, the resin layer 12 and the base material 13 can be adhered to each other simply by their superposition, and therefore, the base material with a fine structure, in which the fine structure 10 of the transfer mold 11 is precisely transferred to the base material, can be manufactured at low cost.

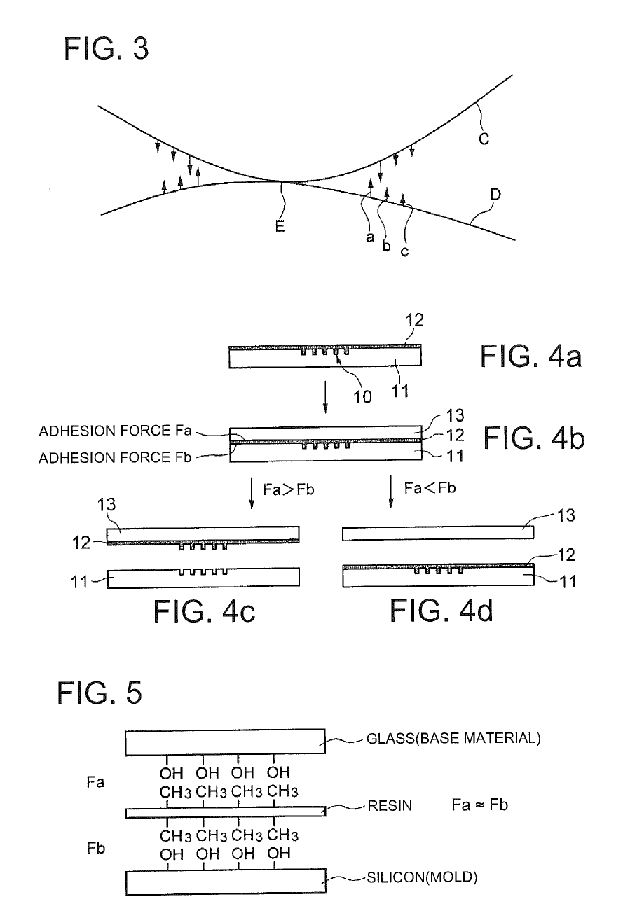

Next, explanation will be made of physical interaction between the resin layer 12 on the transfer mold 11 and the base material 13 in FIG. 1(d) and FIG. 2(b), referring to FIG. 3. FIG. 3 is a side view, which schematically shows the manner that the resin layer 12 and the base material 13 in FIGS. 1 and 2 are adsorbed with each other, in order to explain self adsorption of the two materials.

The two materials C and D are superposed on each other for adhesion. Since the two materials have a different planarity, a certain space occurs between the two materials at initial stage immediately after the superposition of the two materials, and a Newton's ring appears. As a certain period of time elapses (or when pressure is applied to one portion of the superposition), the materials C and D contact each other at the portion E as is shown in FIG. 3. The contact produces attraction forces a, b, and c (a>b>c in the order that the distance between the materials C and D is short) based on intermolecular force between the materials C and D at the vicinity of the portion E, whereby the contact region gradually enlarges as the materials C and D deform each other or as the materials C and D, which are relatively deformable, deform, and finally, the entire surfaces of the two materials adhere to each other.

As described above, when the two materials C and D are superposed on each other, the two materials self-adsorb each other via the above-described physical interaction, resulting in the entire surface adhesion.

Next, three examples (1) through (3), which are the preferred embodiments in FIG. 1, will be explained.

(1) In FIG. 1, the surfaces of the base material and the transfer material layer on the side to self-adsorb are preferably flat. As the surface flatness thereof, the average roughness is preferably not more than 1 nm in terms of a center line average roughness Ra. Herein, the Ra implies that of the surface of the transfer material layer, but not that of the concave and convex structure based the fine structure.

(2) In FIG. 1(d), the self adsorption step may be carried out under atmospheric pressure (ordinary pressure), however, the step is preferably carried out under vacuum (reduced) pressure, since incorporation of air bubble between the base material and the transfer material layer is prevented under such a circumstance, resulting in improvement of the adhesion.

(3) In FIG. 1, it is preferred that the surfaces of the base material and the transfer material layer on the side to self-adsorb have a rigidity such that deformation is produced by the intermolecular force.

### Second Embodiment

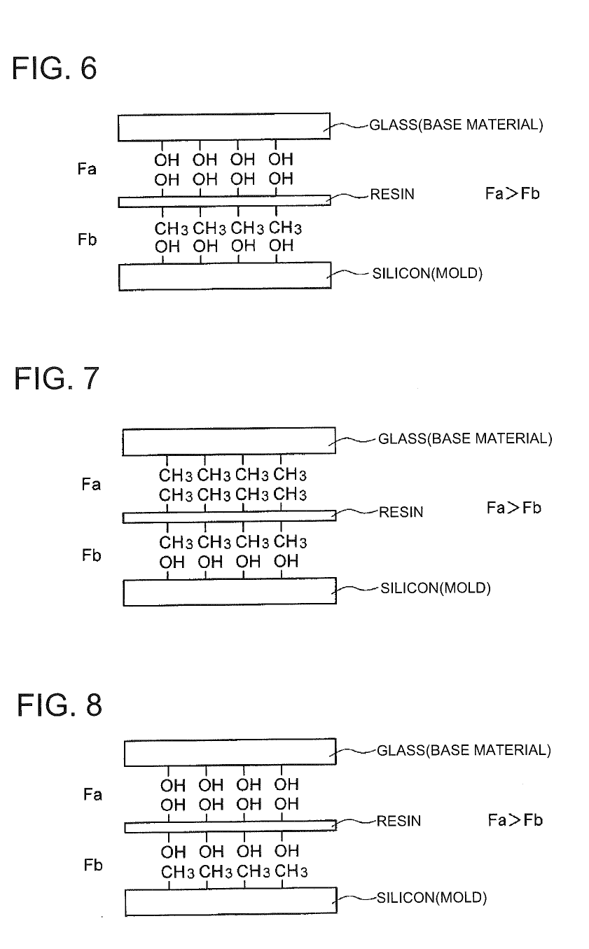

The second embodiment is one in which pre-treatment is carried out (FIGS. 6 and 7) in order to increase the adsorption force between the resin layer 12 and the base material 13 in FIGS. 1 and 2 or to in which each material is selected and suitably combined (FIG. 8).

FIG. 4 is a drawing for explaining a principle in which a resin layer is transferred onto a base material in the base material manufacturing method of FIG. 1 or 2. FIG. 5 is a drawing for explaining adhesion force Fa between the resin and the base material and adhesion force Fb between the resin and the silicon (mold) prior to pre-treatment. FIG. 6 is a drawing for explaining pre-treatment (a first example) according to the embodiment of the invention. Similarly, FIG. 7 is a drawing for explaining pre-treatment (a second example). FIG. 8 is a drawing for explaining a combination (a third example) of each material according to the embodiment of the invention.

The process necessary to transfer a resin layer (a transfer material layer) to a base material in FIGS. 1 and 2 comprises a step of coating and curing a transfer material layer 12 on a transfer mold 11 as is shown in FIG. 4(a), a step of adhering the transfer material layer to a base material 13 via self-adsorption as is shown in FIG. 4(b), and a step of separating the base material with the transfer material layer from the transfer mold as is shown in FIG. 4(c).

In FIG. 4(b), when Fa>Fb is satisfied, wherein Fa represents an adhesion force at an interface between the transfer material layer 12 and the base material 13, and Fb represents an adhesion force at an interface between the transfer material layer 12 and the transfer mold 11, the resin on the transfer mold 11 can be transferred onto the base material, as is shown in FIG. 4(c). On the other hand, when Fa<Fb, the transfer material layer 12 remains on the transfer mold 11, and can not be transferred to the base material.

As is shown in FIG. 5, for example, when a material for the mold is silicon (Si), the transfer material is an acryl resin, and the base material is composed of glass, adhesion forces Fa and Fb at the interfaces in a simple superposition of the materials both are derived from interaction of an —OH group and a —CH₃ group, resulting in Fa≈Fb, which can not provide stable transfer.

In view of the above, the embodiments in the invention realize Fa>Fb as is shown in the following first example to third example.

The first example is such that as is shown in FIG. 6, when a material for the mold is silicon (Si), the transfer material is an acryl resin, and the base material is composed of glass, the resin is subjected to UV ozone treatment as pre-treatment. According to such a pre-treatment, a first —OH group orients on the resin surface and its electrostatic interaction with a second OH group of the glass base material increases adhesion force Fa, realizing Fa>Fb. Moreover, heating treatment, pressing treatment or standstill treatment for a prescribed period of time, which is carried out after the pre-treatment, reduces the distance between the first and second —OH groups, which further increases adhesion force Fa.

The second example is such that as is shown in FIG. 7, when like the first example, a material for the mold is silicon (Si), the transfer material is an acryl resin, and the base material is composed of glass, the surface of the glass (base material) is subjected to primer treatment as the pre-treatment. The pre-treatment, which forms a primer layer on the glass to orient a —CH₃ group on the glass surface, increases adhesion force Fa, realizing Fa>Fb. This is considered to be due to the reason that the —CH₃ group aligns on any of the material surfaces, which increases affinity between molecules, reduces the intermolecular distance and produces a large intermolecular force. Moreover, heating treatment, pressing treatment or standstill treatment for a prescribed period of time, which is carried out after the pre-treatment, reduces the distance between the —CH₃ groups, which further increases adhesion force Fa.

The third example is such that as is shown in FIG. 8, when a material for the mold is a resin, the transfer material is a SOG (spin on glass), and the base material is composed of glass, the adhesion force Fa is increased by electrostatic interaction between the —OH group of SOG and that of the glass base material, realizing Fa>Fb without pre-treatment.

Also in this example, heating treatment, pressing treatment or standstill treatment for a prescribed period of time, which is carried out after adhesion, reduces the distance between the —OH groups, which further increases adhesion force Fa. Further, an appropriate combination of materials used for each of the transfer mold, transfer material and base material can provide adhesion force between the base material and the transfer material layer Fa greater than Fb.

As is shown in FIGS. 6 and 7 described above, the pre-treatment is effective to further increase adhesion between the base material and the transfer material layer (also referred to as resin layer), and enables stable separation of the base material with the transfer material layer from the transfer mold. As such a surface activation treatment, there is mentioned UV ozone treatment, excimer lamp treatment, oxygen ashing treatment or washing treatment such as alkali washing or alcohol washing, whereby adhesion between a resin surface and an inorganic material surface is increased. The adhesion between a resin surface and an inorganic material surface is increased by subjecting glass to the primer treatment, for example, film formation treatment employing an acryl-based silane coupling agent. It is preferred that the methods performed for the pre-treatment as described above are appropriately selected according to materials used for the base material and the transfer material.

As is described in the third example, the adhesion between the base material and the transfer material layer (resin layer) can be further increased without special pre-treatment by an appropriate combination of materials used for the base material and the transfer material.

### Third Embodiment

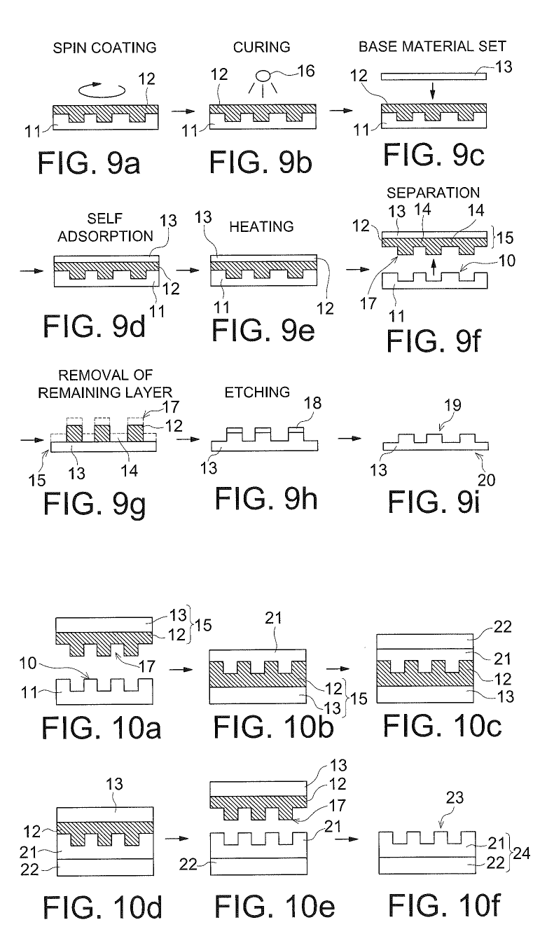

The third embodiment is a nanoimprint lithography method employing the base material manufacturing method of the first or second embodiment. FIG. 9 is a drawing for explaining each of the steps (a) to (i) in the nanoimprint lithography method of the third embodiment.

The steps (a) to (f) in FIG. 9 are the same as those in FIG. 1, and their explanation is omitted. It is preferred that the adhesion between the base material and the resin layer (transfer material layer) is increased in the same manner as in FIGS. 6 to 8.

A base material 15 comprising the base material 13 and the resin layer 12 adhered thereto is obtained by its separation from the mold as is shown in FIG. 9(f). The resin layer 12 of the base material 15 has a fine concave and convex structure 17 formed by inversion of a fine concave and convex structure 10 of the transfer mold 11.

Subsequently, the resin layer 12 on the base material 13, the resin layer having the fine concave and convex structure 17, is subjected to ashing treatment to remove the remaining film 14 at the concave portion of the fine concave and convex structure 17, as is shown in FIG. 9(g). This removal of the remaining film 14 exposes the surface of the base material 13 at the bottom of the concave portion, and at the same time lowers the height of the convex portion, as is shown in dotted lines of the figure.

Subsequently, as the base material 13 is subjected to etching processing employing the resin layer 12 illustrated in FIG. 9(g) as a mask, as is shown in FIG. 9(h). A resin 18 of the resin layer 12 remains, however, the base material 20, in which a fine concave and convex structure 19 corresponding to the fine concave and convex structure 17 is formed on the base material 13, is obtained via additional etching processing, as is shown in FIG. 9(i).

As is described above, employing the base material 15 with the fine concave and convex structure 17 in which the fine concave and convex structure 10 of the transfer mold 11 is inverted, the base material 20 with the fine concave and convex structure 19 formed on the base material 13 is obtained, the fine concave and convex structure 19 being one inverting the fine concave and convex structure 10 of the transfer mold 11.

Prior to the self adsorption step in FIG. 9(d), the surface of the resin layer 12 may be subjected to oxygen ashing treatment so as to activate the surface of the resin layer 12 and reduce the thickness of the resin layer 12. Thus, adhesion between the resin layer 12 and the base material 13 composed of glass is improved at the self adsorption step of FIG. 9(d), and at the same time the thickness of the resin layer 12 is reduced, whereby time required at the remaining film removal step in FIG. 9(g) can be can shortened.

According to the nanoimprint lithography method of the present embodiment, the fine concave and convex structure 10 of the transfer mold 11 can be transferred to the entire surface of the base material 13, independently of the planarity of the transfer mold 11 or the base material 13, wherein in-plane uniformity of the transfer and uniformity of in-plane distribution of the thickness of the remaining film 14 can be achieved, so that accuracy of the transfer material 12 is improved and accuracy of the fine concave and convex structure 19 formed on the base material 13 is also improved.

The thickness of the remaining film 14 of the resin layer 12 is uniform throughout the entire in-plane and the remaining film 14 is uniformly removed by the ashing treatment in FIG. 9(g). Accordingly, the base material 13 is uniformly processed at the etching processing step in FIG. 9(h), so that accuracy of the fine concave and convex structure 19 formed on the base material 13 is improved.

### Fourth Embodiment

The fourth embodiment is a method of obtaining a duplicate of a transfer mold, employing the base material manufacturing method of the first or second embodiment. The first to fifth examples according to this embodiment will be explained below.

The first example is one in which a second generation transfer mold is prepared in the same steps as shown in FIG. 9(a) to FIG. 9(i). That is, the transfer mold 11 of FIG. 9(a) is employed as a first generation transfer mold. When for example, quartz is employed as the base material 13, a base material 20 composed of quartz as shown in FIG. 9(i) is obtained. This base material 20 is a second generation transfer mold composed of quartz.

The second example is one in which a second generation transfer mold is prepared in the same steps as in FIG. 9(a) to FIG. 9(f). That is, the transfer mold 11 of FIG. 9(a) is employed as a first generation transfer mold. The base material 15 is obtained at the separation step in FIG. 9(f), in which the resin layer 12 with the fine concave and convex structure 17 is formed on the base material 13. This base material 15 is a second generation transfer mold composed of resin.

In the same manner as above, when employing, for example, SOG as a transfer material, a SOG layer is formed at the step of FIG. 9(a), a base material 15 is obtained at the separation step in FIG. 9(f), in which the SOG layer with the fine concave and convex structure 17 is formed on the base material 13. This base material 15 is a second generation transfer mold composed of SOG.

Further, employing the base material 13 with the transfer material such as the resin or SOG layer above as a second generation transfer mold, a second base material and a second transfer material, the same steps as described above are repeated to obtain a base material with a fine concave and convex structure formed thereon. The resulting base material may be a third generation transfer mold.

The third example is one in which a third generation transfer mold is prepared employing SOG as a transfer material, as is shown in FIG. 10. FIG. 10 is a drawing for explaining the steps (a) to (f) of a manufacturing method (a third example) of the third generation transfer mold composed of SOG in the present embodiment.

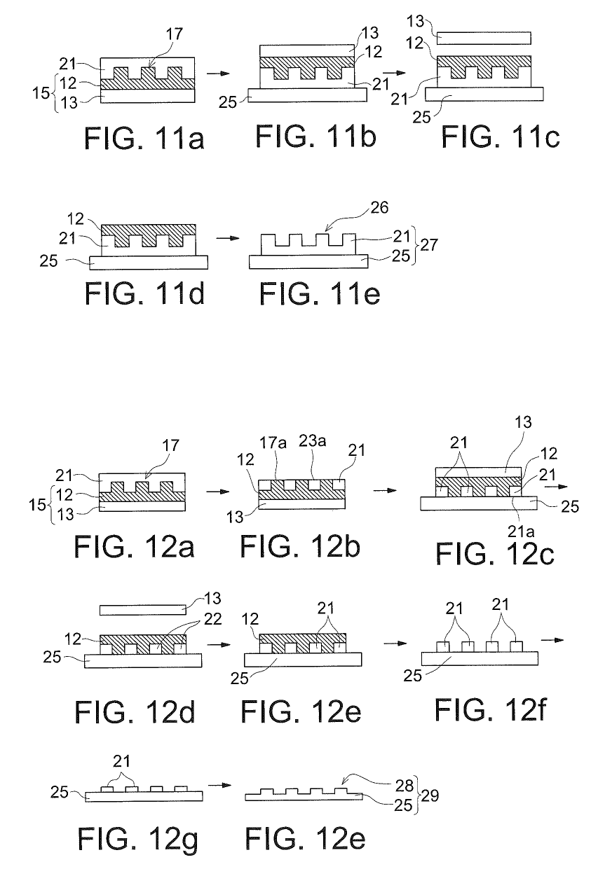

In the third example, the same steps as FIGS. 9(a) to 9(f) are carried out to arrive at the separation step. That is, as is shown in FIG. 11(a), the base material 13 with the resin layer 12 adhered thereon is separated from the transfer mold 11 in the same manner as in FIG. 9(f). A fine concave and convex structure 17, in which the fine concave and convex structure 10 of the transfer mold 11 is inverted, is transferred onto the resin layer 12 on the base material 13.

Subsequently, as is shown in FIG. 10(b), employing the base material 15 with the resin layer 12 thereon as a second transfer mold, an SOG as a second transfer material is spin coated on the resin layer 12 to form an SOG layer 21 as a transfer layer. After that, as is shown in FIG. 10(c), a second base material 22 is adhered onto the SOG layer 21 via self adhesion as described above.

Subsequently, adhesion between the SOG layer 21 and the base material 22 is increased by heat application in FIG. 10(d). After that, as is shown in FIG. 10(e), the SOG layer 21 and the base material 22 are cooled to room temperature, and then the SOG layer 21 with the base material 22 are separated from the resin layer 12 through a separation step.

As is shown in FIG. 10(f), on the SOG layer 21 on the glass base material 22 is transferred a fine concave and convex structure 23 in which the fine concave and convex structure 17 of the resin layer 12 is inverted. Thus, a transfer mold 24 with the fine concave and convex structure 23 is obtained. That is, the transfer mold 24, in which the fine concave and convex is transferred from the transfer mold 11 to the resin layer 12 and then from the resin layer 12 to the SOG layer 21, is a third generation transfer mold

Thus, the third generation transfer mold 24, which is composed of the glass base material 22 and the SOG layer 21 with the fine concave and convex 23, is obtained from the transfer mold 11.

The fourth example is one for manufacturing the third generation transfer mold comprising the SOG employing a manufacturing method different from that of the third example. FIG. 11 is a drawing for explaining the steps (a) to (f) of a manufacturing method (a fourth example) of the third transfer mold comprising an SOG in the present embodiment.

In the fourth example, each step of FIGS. 9(a) to 9(f) is carried out to obtain the base material 15 having the resin layer 12 as the second transfer mold, and then an SOG layer is formed as a second transfer material layer in the same manner as in FIG. 10(b). That is, as is shown in FIG. 11(a), the SOG layer 21 is formed on the resin layer 12.

Subsequently, as is shown in FIG. 11(b), a second base material 25 composed of silicon is adhered onto the SOG layer 21 via self adhesion as is described above. After that, as is shown in FIG. 11(c), the base material 13 is separated from the resin layer 12 in the separation step.

Subsequently, the resin layer 12 is subjected to peeling treatment, ashing treatment or solvent treatment and removed as is shown in FIG. 11(d). As is shown in FIG. 11(e), a fine concave and convex structure 26 is transferred onto the SOG layer 22 in which the fine concave and convex structure 17 of the resin layer 12 is inverted. Thus, a third generation transfer mold 27 having a fine concave and convex structure 26 is obtained.

As described above, the third generation transfer mold 27, which is composed of the silicon base material 25 and the SOG layer with the fine concave and convex 26 formed thereon, is obtained from the transfer mold 11.

In the fourth example, when a base material 13 composed of resin is employed, the separation step in FIG. 11(c) is omitted, and the base material 13 and the resin layer 12 may be integrally separated in the resin removal step in FIG. 11(d).

The fifth example is one for manufacturing the third generation transfer mold comprising quartz as is shown in FIG. 12. FIG. 12 is a drawing for explaining the steps (a) to (h) of a manufacturing method (a fifth example) of the third transfer mold comprising quartz in the present embodiment.

In the fifth example, each step of FIGS. 9(a) to 9(f) is carried out to obtain the base material 15 having the resin layer 12 as a second transfer mold, and then an SOG layer is formed as a second transfer material layer in the same manner as in FIG. 10(b) or FIG. 11(a). That is, as is shown in FIG. 12(a), the SOG layer 21 is formed on the resin layer 12.

Subsequently, as is shown in FIG. 12(b), the SOG layer 21 formed on the resin layer 12 is subjected to etching treatment to reduce the thickness, so that the surface 21a of the SOG layer 21 is approximately the same level as the convex surface 17a of the fine concave and convex structure 17.

Subsequently, as is shown in FIG. 12(c), a second base material 25 composed of silicon is adhered onto the surface 21a of the SOG layer 21 via self adhesion as is described above. After that, as is shown in FIG. 12(d), the base material 13 is separated from the resin layer 12 in the separation step in FIG. 12(d).

Subsequently, the resin layer 12 of FIG. 12(e) is subjected to peeling treatment, ashing treatment or solvent treatment to remove. Thus, the convex portions of the SOG layer 21 remain on the base material 25 as is shown in FIG. 12(f).

Subsequently, the silicon base material 25 of FIG. 12(f) is subjected to etching treatment employing the SOG layer 21 as a mask, thereby processing the silicon base material 25. Residual portions of the SOG layer 21, if still present, are subjected to further etching treatment. Thus, as is shown in FIG. 12(f), a third generation transfer mold 29 is obtained, which comprises the silicon base material 25 and formed thereon, a fine concave and convex structure 28 corresponding to the fine concave and convex structure 17 of the resin layer 12.

As described above, the third generation transfer mold 29, which comprises the base material 25 and provided thereon, the fine concave and convex 28, is obtained from the transfer mold 11.

In the fifth example, when a base material 13 composed of resin is employed, the separation step in FIG. 12(d) is omitted, and the base material 13 and the resin layer 12 may be integrally separated in the resin removal step in FIG. 12(e).

The method according to FIG. 12 forms the fine concave and convex structure 28 on the base material 25, and can be put into practical use as one of nanoimprint lithography methods.

According to the mold duplicating method of the invention, the fine concave and convex structure 10 of the mold 11 can be transferred to the entire surface of the base material, independently of the planarity of the transfer mold 11 or the base material 13, wherein in-plane uniformity of the transfer and uniformity of in-plane distribution of the thickness of the remaining layer can be achieved, so that accuracy of the transfer material layer is improved, and therefore, a transfer mold can be duplicated with high precision. A mold (a first generation mold) is expensive to manufacture, and of high price, however, the method makes it possible to manufacture a duplicate mold (a second generation mold) with high precision at low cost.

### EXAMPLES

Next, the present invention will be explained in more detail employing examples, but the invention is not specifically limited thereto.

### Example 1

A silicon wafer (4 inch, a thickness of 0.525 mm, and a flatness PV of 5 μm (an effective diameter of 50 mm)) was employed as a material for a transfer mold. A resist mask prepared via electron beam writing was formed on the mold, followed by dry etching to form a fine structure periodically having a fine concave and convex structure in the mold. This fine structure had a hole array structure having a structural period of 620 nm, a hole diameter of 310 nm and a structural depth of 200 nm.

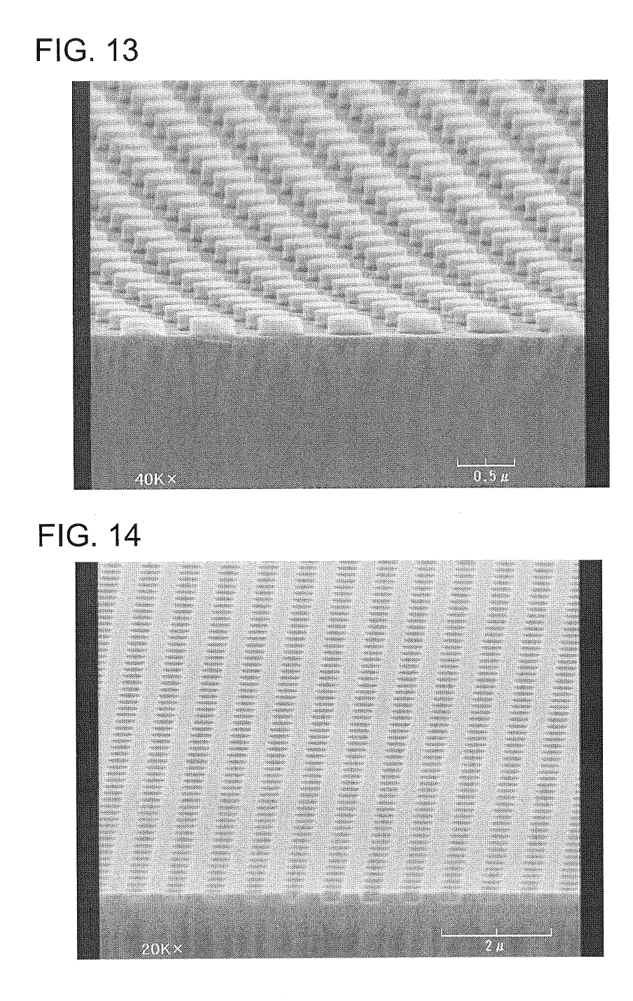

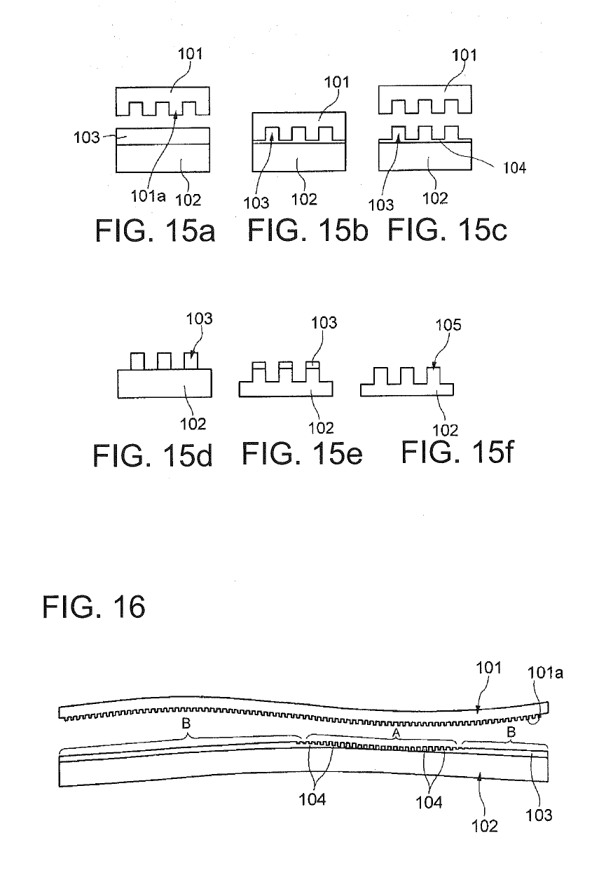

An acryl based ultraviolet ray curable resin PAK02 (produced by Toyo Gosei Kogyo Co., Ltd.) as a transfer material was coated on the transfer mold according to a spin coating method (at 3000 rpm for 60 seconds), and irradiated with ultraviolet rays with a peak wavelength of 365 nm for 1 minute under nitrogen atmosphere to cure the ultraviolet ray curable resin, thereby forming a cured transfer material layer. The surface of the resulting transfer material layer was subjected to UV ozone treatment (the UV light source: a low pressure mercury lamp, a treatment time: 2 minutes), thereby activating the transfer material layer surface (—OH orientation). A quartz glass (3 inch, a thickness of 0.6 mm, a flatness PV of 2 μm, (effective diameter: 50 mm)) as a base material was superposed on the transfer material layer and adhered to the transfer material layer via self adsorption force (intermolecular force). Thereafter, heat treatment (at 120° C. for 20 seconds) was carded out to increase adhesion between the base material and the transfer material layer, followed by cooling to room temperature and separation. Thus, the transfer material layer with the fine structure was transferred onto the surface of the base material, as is shown in FIG. 13. In FIG. 13 is shown a scanning electron micrograph of the fine structure of the surface of the base material onto which the transfer material layer was transferred in Example 1.

### Modification Example 1

In a modification example of Example 1, in which another glass such as quartz glass or pyrex (trade name) glass, SOG (spin on glass) or their composite (glass coated with SOG) was employed as a material of the transfer mold, the same transfer as Example 1 was performed.

Further, also when an EB (electron beam) resist, a photoresist, a heat curable resin, or a thermoplastic resin was employed as the transfer material, the same transfer as above was performed.

Further, also when any treatments of excimer lamp treatment (2 minutes), oxygen ashing (an ICP etching apparatus 5 Pa, 150 W, 30 sccm, 1 minute), and alkali washing and alcohol washing (5 minute immersion in 0.1% NaOH and 1 minute immersion in IPA) were carried out as the surface activation treatment, the same transfer as above was performed. Furthermore, nitrogen plasma treatment (an ICP etching apparatus, 5 Pa, 150 W, 30 second cm, 1 minute), carried out after the above surface activation treatment, can further improve an adhesion property.

### Example 2

A silicon wafer (4 inch, a thickness of 0.525 mm, and a flatness PV of 5 μm (an effective diameter of 50 mm)) was employed as a material for a transfer mold. A resist mask prepared via electron beam writing was formed on the mold, followed by dry etching to form a fine structure. This structure had a hole array structure having a structural period of 620 nm, a hole diameter of 310 nm and a structural depth of 200 nm.

An acryl based ultraviolet ray curable resin (PAK02, produced by Toyo Gosei Kogyo Co., Ltd.) as a transfer material was coated on this transfer mold according to a spin coating method (at 3000 rpm for 60 seconds), and irradiated with ultraviolet light with a peak wavelength of 365 nm for 1 minute under nitrogen atmosphere to cure the ultraviolet ray curable resin, thereby forming a cured transfer material layer. As a base material, a polyimide resin base material (3 inch, a thickness of 0.6 mm, and a flatness PV of 5 μm (effective diameter: 50 mm)) was employed. The surfaces of the base material and the transfer material layer were subjected to UV ozone treatment (the UV light source: a low pressure mercury lamp, a treatment period of time: 2 minutes), thereby activating the surfaces of the base material and the transfer material layer (—OH orientation). The base material and the transfer material layer were adhered to each other together via self adsorption force (intermolecular force). Thereafter, heat treatment (at 120° C. for 20 seconds) was carried out to increase adhesion between the base material and transfer material layer, followed by cooling to room temperature and separation. Thus, the transfer material layer with the fine structure was transferred onto the surface of the base material.

### Modification Example 2

In a modification example of Example 2, in which another glass such as quartz glass or pyrex (trade name) glass, SOG (spin on glass) or their composite (glass coated with SOG) was employed as a material of the transfer mold, the same transfer as Example 2 was performed.

Further, also when any treatments of excimer lamp treatment (2 minutes), oxygen ashing (an ICP etching apparatus 5 Pa, 150 W, 30 sccm, 1 minute), and alkali washing and alcohol washing (5 minute immersion in 0.1% NaOH and 1 minute immersion in IPA) were carried out as the surface activation treatment, the same transfer as above was performed. Furthermore, nitrogen plasma treatment (an ICP etching apparatus, 5 Pa, 150 W, 30 second cm, 1 minute), carried out after the above surface activation treatment, can further improve an adhesion property.

### Example 3

A resin (an acryl based ultraviolet ray curable resin with a fine structure, the resin being formed on quartz) was employed as a material for a transfer mold. An acryl based ultraviolet ray curable resin PAK02 (produced by Toyo Gosei Kogyo Co., Ltd.) as a transfer material was coated on the transfer mold according to a spin coating method (at 3000 rpm for 60 seconds), and irradiated with ultraviolet rays with a peak wavelength of 365 nm for 1 minute under nitrogen atmosphere to cure the ultraviolet ray curable resin, thereby forming a cured transfer material layer. The surface of the resulting transfer material layer was subjected to UV ozone treatment (the UV light source: a low pressure mercury lamp, a treatment time: 2 minutes), thereby activating the transfer material layer surface (—OH orientation). A quartz glass (3 inch, a thickness of 0.6 mm, and a flatness PV of 2 μm, (effective diameter: 50 mm)) as a base material was superposed on the transfer material layer and adhered to the transfer material layer via self adsorption force (intermolecular force). Thereafter, heat treatment (at 120° C. for 20 seconds) was carried out to increase adhesion between the base material and transfer material, followed by cooling to room temperature and separation. Thus, the transfer material layer with the fine structure was transferred onto the surface of the base material.

### Modification Example 3

In a modification example of Example 3, in which an EB resist, a photo resist, a heat curable resin or a thermoplastic resin was employed as a material of the transfer mold, the same transfer as Example 3 was carried out.

Further, also when a mold made of polycarbonate, which was prepared by injection molding, was employed as the transfer mold, the same transfer as above was performed.

Further, also when an EB resist, a photoresist, a heat curable resin or a thermoplastic resin was employed as the transfer material, the same transfer as above was performed.

Further, also when any treatments of excimer lamp treatment (2 minutes), and oxygen ashing (an ICP etching apparatus 5 Pa, 150 W, 30 sccm, 1 minute) were carried out as the surface activation treatment, the same transfer as above was performed. Nitrogen plasma treatment (an ICP etching apparatus, 5 Pa, 150 W, 30 second cm, 1 minute), carried out after the above surface activation treatment, can further improve an adhesion property.

Furthermore, also when another glass such as pyrex (trade name) glass, SOG, silicon or their composite (glass coated with SOG) was employed as a material of the base material, the same transfer as above performed.

### Example 4

A resin (an acryl based ultraviolet ray curable resin with a fine structure, the resin being formed on quartz) was employed as a material for a transfer mold. An acryl based ultraviolet ray curable resin PAK02 (produced by Toyo Gosei Kogyo Co., Ltd.) as a transfer material was coated on the transfer mold according to a spin coating method (at 3000 rpm for 60 seconds), and irradiated with ultraviolet rays with a peak wavelength of 365 nm for 1 minute under nitrogen atmosphere to cure the ultraviolet ray curable resin, thereby forming a cured transfer material layer. As a base material, a polyimide resin base material (3 inch, a thickness of 0.6 mm, and a flatness PV of 5 μm (effective diameter: 50 mm)) was employed. The surfaces of the base material and the transfer material layer were subjected to UV ozone treatment (the UV light source: a low pressure mercury lamp, a treatment period of time: 2 minutes), thereby activating the surfaces of the base material and the transfer material layer (—OH orientation). The base material and the transfer material layer were adhered to each other together via self adsorption force (intermolecular force). Thereafter, heat treatment (at 120° C. for 20 seconds) was carried out to increase adhesion between the base material and transfer material layer, followed by cooling to room temperature and separation. Thus, the transfer material layer with the fine structure was transferred onto the surface of the base material.

### Modification Example 4

In a modification example of Example 4, in which an EB resist, a photo resist, a heat curable resin or a thermoplastic resin was employed as a material of the transfer mold, the same transfer as Example 3 was performed.

Further, also when a mold made of polycarbonate, which was prepared by injection molding, was employed as the transfer mold, the same transfer as above was performed.

Further, also when an EB resist, a photoresist, a heat curable resin or a thermoplastic resin was employed as the transfer material, the same transfer as above was performed.

Furthermore, also when any treatments of excimer lamp treatment (2 minutes) and oxygen ashing (an ICP etching apparatus 5 Pa, 150 W, 30 sccm, 1 minute) were employed as the surface activation treatment, the same transfer as above was performed.

### Example 5

A resin (an acryl based ultraviolet ray curable resin with a fine structure, the resin being formed on quartz) was employed as a material for a transfer mold. SOG (OCD T-12, produced by Tokyo Oka Kogyo Co., Ltd.) as a transfer material was coated on the transfer mold according to a spin coating method (at 6000 rpm for 30 seconds) to form a transfer material layer. Thereafter, the surface of the resulting transfer material layer was subjected to UV ozone treatment (the UV light source: a low pressure mercury lamp, a treatment time: 2 minutes), thereby activating the transfer material layer surface (—OH orientation). A quartz glass (3 inch, a thickness of 0.6 mm, and a flatness PV of 2 μm (effective diameter: 50 mm)) as a base material was superposed on the transfer material layer and adhered to the transfer material layer via self adsorption force (intermolecular force). Thereafter, heat treatment (at 120° C. for 20 seconds) was carried out to increase adhesion between the base material and the transfer material layer, followed by cooling to room temperature and separation. Thus, the transfer material layer with the fine structure was transferred onto the surface of the base material. Incidentally, after SOG, employed in this example, was spin coated, the solvent rapidly volatilized to complete curing. When SOG whose solvent is difficult to volatilize is employed, the solvent volatilization may be promoted by baking treatment for curing.

### Modification Example 5

In a modification example of Example 5, in which an EB resist, a photo resist, a heat curable resin or a thermoplastic resin was employed as a material of the transfer mold, the same transfer as Example 3 was carried out.

Further, also when a mold made of polycarbonate, which was prepared by injection molding, was employed as the transfer mold, the same transfer as above was performed.

Further, also when any treatments of excimer lamp treatment (2 minutes) and oxygen ashing (an ICP etching apparatus 5 Pa, 150 W, 30 sccm, 1 minute) were carried out as the surface activation treatment, the same transfer as above was performed. Furthermore, nitrogen plasma treatment (an ICP etching apparatus, 5 Pa, 150 W, 30 second cm, 1 minute), carried out after the above surface activation treatment, can further improve an adhesion property.

Furthermore, also when another glass such as pyrex (trade name) glass, SOG, silicon or their composite (glass coated with SOG) was employed as a material of the base material, the same transfer as above was performed.

### Example 6

A resin (an acryl based ultraviolet ray curable resin with a fine structure, the resin being formed on quartz) was employed as a material for a transfer mold. SOG (OCD T-12, produced by Tokyo Oka Kogyo Co., Ltd.) as a transfer material was coated on the transfer mold according to a spin coating method (at 6000 rpm for 30 seconds) to form a transfer material layer. As a base material, a polyimide resin base material (3 inch, a thickness of 0.6 mm, and a flatness PV of 5 μm (effective diameter: 50 mm)) was employed. The surfaces of the base material and the transfer material layer were subjected to UV ozone treatment (the UV light source: a low pressure mercury lamp, a treatment period of time: 2 minutes), thereby activating the surfaces of the base material and the transfer material layer (—OH orientation). The base material and the transfer material layer were adhered to each other together via self adsorption force (intermolecular force). Thereafter, heat treatment (at 120° C. for 20 seconds) was carried out to increase adhesion between the base material and the transfer material layer, followed by cooling to room temperature and separation. Thus, the transfer material layer with the fine structure was transferred onto the surface of the base material.

### Modification Example 6

In a modification example of Example 6, in which an EB resist, a photo resist, a heat curable resin or a thermoplastic resin was employed as a material of the transfer mold, the same transfer as Example 6 was carried out.

Further, also when a mold made of polycarbonate, which was prepared by injection molding, was employed as the transfer mold, the same transfer as above was performed.

Further, also when any treatments of excimer lamp treatment (2 minutes) and oxygen ashing (an ICP etching apparatus 5 Pa, 150 W, 30 sccm, 1 minute) were carried out as the surface activation treatment, the same transfer as above was performed. Furthermore, nitrogen plasma treatment (an ICP etching apparatus, 5 Pa, 150 W, 30 second cm, 1 minute), carried out after the above surface activation treatment, can further improve an adhesion property.

### Example 7

A resin (an acryl based ultraviolet ray curable resin with a fine structure, the resin being formed on quartz) was employed as a material for a transfer mold. SOG (OCD T-12, produced by Tokyo Oka Kogyo Co., Ltd.) as a transfer material was coated on the transfer mold according to a spin coating method (at 6000 rpm for 30 seconds) to form a transfer material layer. A quartz glass (3 inch, a thickness of 0.6 mm, and a flatness PV of 2 μm (effective diameter: 50 mm)) was employed as a base material. The surfaces of the base material and the transfer material layer were subjected to primer treatment (KBM 503, produced by Shin-etsu Kagaku Co., Ltd., spin coated at 3000 rpm for 30 seconds, and heat treated at 120° C. for 1 minute). The base material and the transfer material layer were adhered to each other together via self adsorption force (intermolecular force). Thereafter, heat treatment (at 120° C. for 20 seconds) was carried out to increase adhesion between the base material and the transfer material layer, followed by cooling to room temperature and separation. Thus, the transfer material layer with the fine structure was transferred onto the surface of the base material.

### Modification example 7

In a modification example of Example 7, in which an EB resist, a photo resist, a heat curable resin or a thermoplastic resin was employed as a material of the transfer mold, the same transfer as Example 7 was carried out.

Further, also when a mold made of polycarbonate, which was prepared by injection molding, was employed as the transfer mold, the same transfer as above was performed.

Further, also when another glass such as pyrex (trade name) glass, SOG, silicon or their composite (glass coated with SOG) was employed as a material of the base material, the same transfer as above was performed.

### Example 8

Example 8 duplicates the transfer mold by repeating the process twice. A silicon wafer (4 inch, a thickness of 0.525 mm, and a flatness PV of 5 μm (an effective diameter of 50 mm)) was employed as a material for a transfer mold. A resist mask prepared via electron beam writing was formed on the mold, followed by dry etching to form a fine structure in the mold. This fine structure had a hole array structure having a structural period of 620 nm, a hole diameter of 310 nm and a structural depth of 200 nm. An acryl based ultraviolet ray curable resin PAK02 (produced by Toyo Gosei Kogyo Co., Ltd.) as a transfer material was coated on the transfer mold according to a spin coating method (at 3000 rpm for 60 seconds), and irradiated with ultraviolet rays with a peak wavelength of 365 nm for 1 minute under nitrogen atmosphere to cure the ultraviolet ray curable resin, thereby forming a cured transfer material layer. The surface of the resulting transfer material layer was subjected to UV ozone treatment (the UV light source: a low pressure mercury lamp, a treatment time: 2 minutes), thereby activating the transfer material layer surface (—OH orientation). A quartz glass (3 inch, a thickness of 0.6 mm, and a flatness PV of 2 μm (effective diameter: 50 mm)) as a base material was superposed on the transfer material layer and adhered to the transfer material layer via self adsorption force (intermolecular force). Thereafter, heat treatment (at 120° C. for 20 seconds) was carried out to increase adhesion between the base material and the transfer material layer, followed by cooling to room temperature and separation. Thus, the transfer material layer with the fine structure was transferred onto the surface of the base material.

The structure of the resin transferred on the quartz was employed as a second generation transfer mold. SOG (OCD T-12, produced by Tokyo Oka Kogyo Co., Ltd.) as a second transfer material was coated on the second generation transfer mold according to a spin coating method (at 6000 rpm for 30 seconds) to form a second transfer material layer. A quartz glass (3 inch, a thickness of 0.6 mm, and a flatness PV of 2 μm (effective diameter: 50 mm)) was employed as a second base material. The quartz glass was adhered to the second transfer material layer via self adsorption force (intermolecular force). Thereafter, heat treatment (at 120° C. for 20 seconds) was carried out to increase adhesion between the base material and the transfer material layer, followed by cooling to room temperature and separation, whereby the transfer material having a fine structure was transferred to the base material. Thus, as is shown in FIG. 14, a mold, to which the fine structure of the transfer mold was transferred, was duplicated and obtained as a third generation transfer mold. FIG. 14 shows a scanning electron micrograph of the fine structure of the transfer mold duplicated from the transfer mold in Example 2.

### Example 9

Example 9 is an application to a nanoimprint lithography method. A silicon wafer (4 inch, a thickness of 0.525 mm and a flatness PV of 5 μm (an effective diameter of 50 mm)) was employed as a material for a transfer mold. A resist mask prepared via electron beam writing was formed on the mold, followed by dry etching to form a fine structure. This fine structure had a hole array structure having a structural period of 620 nm, a hole diameter of 310 nm and a structural depth of 200 nm. An acryl based ultraviolet ray curable resin (PAK02, produced by Toyo Gosei Kogyo Co., Ltd.) as a transfer material was coated on this transfer mold according to a spin coating method (at 3000 rpm for 60 seconds), and irradiated with ultraviolet light with a peak wavelength of 365 nm for 1 minute under nitrogen atmosphere to cure the ultraviolet ray curable resin, thereby forming a transfer material layer with a thickness of 1 μm on the transfer mold. The surface of the transfer material layer was subjected to oxygen ashing treatment for 4 minutes to reduce the resin layer thickness to 50 nm. A quartz glass (3 inch, a thickness of 0.6 mm, and a flatness PV of 2 μm (effective diameter: 50 mm)) as a base material was superposed on the transfer material layer and adhered to the transfer material layer via self adsorption force (intermolecular force). Thereafter, heat treatment (at 120° C. for 20 seconds) was carried out to increase adhesion between the base material and the transfer material layer, followed by cooling to room temperature and separation. Thus, the transfer material with the fine structure was transferred onto the surface of the base material.

The transfer material layer on the quartz glass was subjected to further oxygen ashing treatment for 10 seconds to remove the remaining transfer material layer, thereby exposing the surface of the quartz glass. The quartz glass was subjected to dry etching treatment (an ICP etching apparatus, a CHF₃ gas, for 1 minute), employing the transfer material layer as a mask, whereby a fine structure was formed on the quartz glass. This fine structure had a structural period of 620 nm, a pillar diameter of 310 nm and a structural depth of 200 nm.

### Modification Example 8

In the example 1 through 9 and the modification examples 1 through 7, heat treatment was carried after the self adsorption out to increase the adhesion. However, also when the adhered materials after the self adsorption were allowed to stand for a given period of time (12 hours) instead of heat treatment, the fine structure was similarly transferred onto the surface of the base material.

### Modification Example 9

In the example 1 through 9 and the modification examples 1 through 7, heat treatment was carried out after the self adsorption to increase the adhesion. However, also when the adhered materials after the self adsorption were subjected to pressure application treatment (at 4 MPa for 1 minute) instead of heat treatment, the fine structure was similarly transferred onto the surface of the base material.

### Modification Example 10

In the example 1 through 9 and the modification examples 1 through 7, heat treatment was carried out after the self adsorption to increase the adhesion. However, also when the adhered materials after the self adsorption were subjected to electrostatic treatment (1000 V was applied for 30 seconds) instead of heat treatment, the fine structure was similarly transferred onto the surface of the base material.

### Modification Example 11

It is preferred that in the base material and the transfer material layer adhered to each other by self adsorption in Examples 1 through 9 and modification examples 1 through 10, the surfaces on the side that the base material and the transfer material layer face each other are rigid such that deformation due to intermolecular force occurs. In the case those surfaces are those of FEMPAX glass base plates, tests were carried out changing the outer diameter and the thickness of the base material and the transfer material layer. The results are shown in Table 1. A combination of the outer diameter and the thickness in the base material and the transfer material layer is preferably one (one which is represented by “A” in Table 1) in which adsorption occurs.

TABLE 1

| | | | | | | | | | |
|---|---|---|---|---|---|---|---|---|---|
| Thickness | 1.1 | C | C | C | B | B | B | A | A |
| (mm) | 1 | C | C | C | B | B | A | A | A |
| | 0.9 | C | C | C | B | A | A | A | A |
| | 0.8 | C | B | B | A | A | A | A | A |
| | 0.7 | B | A | A | A | A | A | A | A |
| | 0.6 | A | A | A | A | A | A | A | A |
| | 0.5 | A | A | A | A | A | A | A | A |
| | 0.4 | A | A | A | A | A | A | A | A |
| | 0.3 | A | A | A | A | A | A | A | A |
| | | 1 | 2 | 3 | 4 | 5 | 6 | 7 | 8 |

Outer Diameter (inch)
A Self adsorption is carried out
B Self adsorption is carried out by pressure application or by
C Self adsorption is not carried out

### Example 10

In the above examples and modification examples, the base material and the transfer material were adhered to each other at an ordinary temperature and an ordinary pressure. In this example, the same procedures as Example 1 were carried out except for the adhesion step. In this example, the adhesion step was carried out at an ordinary temperature in a vacuum chamber of 10 Pa in order to prevent incorporation of air foam and increase the yield, whereby adhesion was carried out by self adsorption (intermolecular force). Thereafter, heat treatment (at 120° C. for 20 seconds) was carried out under atmospheric pressure to increase adhesion between the base material and the transfer material layer, followed by cooling to room temperature and separation. Thus, the transfer material layer with the fine structure was transferred onto the surface of the base material.

### Example 11

In this example, the same procedures as Example 1 were carried out except that the transfer material layer was formed via a vapor deposition method. A PMMA (polymethyl methacrylate) layer with a thickness of 200 nm as the transfer material layer was formed on the transfer mold via a vacuum vapor deposition method. The same procedures were carried out except for this deposition step, and the transfer material layer with the fine structure was transferred onto the surface of the base material.

As described above, the embodiments, examples and the modification examples of the invention are explained, but the invention is not specifically limited thereto. Various modifications thereof are possible as long as they are within the technical conception of the invention. For example, a transfer material layer may be formed on a transfer mold via a vapor deposition method, a vapor deposition polymerization method, a CVD method or a spattering method. A material other than resins can be employed as a transfer material. When a transfer material layer is formed via a vapor deposition method, a vapor deposition polymerization method, a CVD method or a spattering method, depressions may occur on the transfer material layer surface, influenced by the fine structure of a transfer mold, however, there is no problem as long as self adsorption between a transfer material and a base material is achieved as explained in FIG. 3.

Curing treatment according to solvent volatilization can be carried out due to kinds of materials employed. Curing proceeds via solvent volatilization in a photoresist, an electron ray resist or SOG. For example, ZEP520A (produced by Nippon Zeon) as an electron ray resist, which is a polystyrene based copolymer anisole solution, is coated via a spin coating method and subjected to heat treatment to evaporate the solvent, thereby forming a cured thin layer. Further, for example, an inorganic SOG OCD T-12 (produced by Tokyo Oka Kogyo Co., Ltd.), which is a hydrosiloxane polymer propylene glycol dimethyl ether solution, is coated via a spin coating method and subjected to heat treatment to evaporate the solvent, thereby forming a cured thin layer (Actually, the solvent is likely to evaporate, and the solvent volatilizes immediately after the coating to form a cured layer). An ultraviolet ray curable resin or a thermoplastic resin, in which the main component before curing is a polymer precursor, is cured only via ultraviolet ray irradiation or only via heat application treatment, respectively. Where a thin layer is desirably formed, an ultraviolet ray curable resin or a thermoplastic resin each diluted by a solvent is employed. In this case, an ultraviolet ray curable resin layer or a thermoplastic resin layer, each of which has been formed by spin coating, is subjected to heat treatment to volatilize the solvent, followed by ultraviolet ray curing treatment or heat curing treatment, respectively. For example, PAK-01 (produced by Toyo Gosei Kogyo Co., Ltd.) as an ultraviolet ray curable resin is an acryl resin precursor, and those of various dilution rates are available on the market. These are coated via a spin coating method, followed by solvent volatilization and then ultraviolet ray irradiation, thereby obtaining a cured thin layer.

When the base material and the transfer material are adhered to each other under reduced pressure in a vacuum chamber as in Example 10, the heat treatment step and separation step also may be carried out under reduced pressure in a vacuum chamber.

### APPLICATION FOR INDUSTRIAL USE

The base material manufacturing method of the invention makes it possible to manufacture a base material with a mold structure transferred with high transfer accuracy, the mold structure being formed onto the base material by transfer of the mold structure of a transfer mold, and to manufacture a base material with various fine concave and convex structures according to objects at low cost. Employing such a material, patterned media or discrete media such as a hard disc, and an optical disc, a micro-lens array, a grating lens and a diffraction lattice can be manufactured with high accuracy, and a nanoimprint lithography method or a transfer mold duplicating method can be applied with high accuracy.

### EXPLANATION OF SYMBOLS

10. Fine Concave and Convex Structure
11. Transfer Mold
12. Resin Layer, Transfer Material Layer
13. Base Material
14. Remaining Layer
15. Base Material
17, 19, 23, 26, 28. Fine Concave and Convex Structure
20. Base Material
21. SOG Layer, Transfer Material Layer
22, 25. Base Material

1. A base material manufacturing method comprising the steps of:
forming a cured transfer material layer composed of a transfer material on a transfer mold;
superposing, on the surface of the cured transfer material layer, a base material having a surface capable of adhering to the cured transfer material layer by physical interaction, whereby the cured transfer material layer and the base material are adhered to each other together to form an integrated material; and
then separating the integrated material from the transfer mold to obtain a base material with the cured transfer material layer transferred thereon.

2. The base material manufacturing method of claim 1, wherein the superposing is carried out at ordinary temperature and at ordinary pressure.

3. The base material manufacturing method of claim 1, wherein the superposing is carried out at ordinary temperature and at reduced pressure.

4. The base material manufacturing method of claim 1, the transfer mold having a fine structure and the transfer material layer having a first surface facing the fine structure and a second surface facing the base material, wherein the fine structure is transferred onto the first surface of the transfer material layer.

5. The base material manufacturing method of claim 1, wherein the transfer material comprises at least one selected from an ultraviolet ray curable resin, a heat curable resin, a thermoplastic resin, a photoresist, an electron beam resist and a spin on glass (SOG).

6. The base material manufacturing method of claim 1, wherein the transfer material is coated on the transfer mold and then cured, whereby the transfer material layer is formed.

7. The base material manufacturing method of claim 6, wherein the transfer material is coated on the transfer mold employing at least one selected from a spin coating method, a spray coating method, a dip coating method and a bar coating method.

8. The base material manufacturing method of claim 6, wherein the coated transfer material layer is cured employing at least one curing treatment selected from ultraviolet ray curing treatment, heat curing treatment and solvent volatilization treatment.

9. The base material manufacturing method of claim 1, wherein the transfer material layer is formed on the transfer mold employing at least one selected from vapor deposition, vapor deposition polymerization, CVD and spattering.

10. The base material manufacturing method of claim 1, wherein the transfer mold is composed of at least one selected from silicon, quartz, SOG, a resin and a metal.

11. The base material manufacturing method of claim 1, wherein the base material is composed of at least one selected from quartz, glass, silicon, a resin and a metal.

12. The base material manufacturing method of claim 1, wherein materials for the base material, the transfer material layer and the transfer mold are combined so that the adhesion force between the base material and the transfer material layer is greater than that between the transfer material layer and the transfer mold.

13. The base material manufacturing method of claim 1, wherein prior to the superposing, at least one of surfaces of the base material and the transfer material layer, the surfaces adhering to each other, is subjected to pre-treatment so that the adhesion force between the base material and the transfer material layer is greater than that between the transfer material layer and the transfer mold.

14. The base material manufacturing method of claim 13, wherein the pre-treatment is carried out employing one selected from UV ozone treatment, primer treatment, oxygen ashing treatment, charging treatment, nitrogen plasma treatment and washing treatment.

15. The base material manufacturing method of claim 1, wherein the integrated material was allowed to stand for a certain period of time or subjected to heat treatment, electrostatic adsorption treatment or pressure application treatment, followed by the separation.

16. A nanoimprint lithography method comprising the step of subjecting the base material manufactured according to the base material manufacturing method of claim 1 to lithography processing, employing the transfer material layer as a mask.

17. A nanoimprint lithography method comprising the steps of transferring another transfer material layer onto another base material, employing the transfer material layer of the base material manufactured according to the base material manufacturing method of claim 1, and subjecting the another base material with another transfer material layer transferred to lithography processing employing the another transfer material layer as a mask.

18. A mold duplicating method comprising the step of duplicating a transfer mold, employing the base material with the transfer material layer transferred thereon manufactured according to the base material manufacturing method of claim 1.

19. The mold duplicating method of claim 18, wherein the base material with the transfer material layer transferred thereon is a second generation transfer mold.

20. The mold duplicating method of claim 18, the method comprising the steps of transferring a second transfer material layer onto a second base material, employing the base material with the transfer material layer transferred thereon as a second generation transfer mold, obtaining a second base material with the second transfer material layer transferred thereon, and manufacturing a third generation transfer mold employing the second base material with the second transfer material layer transferred thereon.
